(19) United States
(12) Patent Application Publication
(10) Pub. No.: US 2003/0160764 A1
(43) Pub. Date: Aug. 28, 2003

(54) Power saving device

(76) Inventor: Yen-Liang Kuan, Jia Yi City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/082,298

(22) Filed: Feb. 26, 2002

(51) Int. Cl. G09G 5/08

(52) U.S. Cl. 345/163

(57) ABSTRACT

The present invention is a power saving device disposed in a mouse and comprises at least one sensor both contacts of which connect to a battery and a signal emitter respectively, and one window disposed on an upper surface of a mouse housing. The sensor is in the mouse housing disposed under the window and uses the battery as an operating power supply. When the user holds the mouse and blocks the window, the sensor receives a correct signal and connects the operating power supply of the signal emitter to make the mouse operate normally. When the user does not use the computer for a while and the mouse is in a suspending mode, the sensor receives an incorrect signal to disconnect the operating power supply so the signal emitter of the mouse does not need to perform scanning continuously any more. In the meantime, the battery with a very small amount of power supplies the sensor and, thus, the life of the battery is increased.

### BACKGROUND OF THE INVENTION

1. Field of the Invention

The present invention relates to a power saving device, more particularly to a device applied in a mouse. The signal emitter of the mouse does not need to scan continuously in the suspending mode. Since only a very small amount of power is consumed, the life of the battery is increased significantly.

2. Description of the Prior Art

A wireless mouse needs an independent battery as an operation power supply for the signal emitter. In addition to the signal emitter that performs scanning continuously in the suspending mode, such battery shall supply power for the operation of a mouse pointer sensor, a micro device and other components. Thus, both in the suspending mode and in the operation, the mouse consumes the power of the battery. However, due to the limited electric voltage, the battery of the mouse is replaced when the mouse is used for a certain of time. Especially, the signal emitter and receiver of the mouse continuously consume the power even the user does not use the computer for a while.

### SUMMARY OF THE INVENTION

The primary objective of the present invention is to provide a power saving device comprising an sensor acting as a wake-up sensor. The sensor disconnects the power supply of a signal emitter so that such signal emitter does not need to continuously perform scanning when the mouse on which the signal emitter is mounted is in a suspending mode. In the meantime, a battery with a very small amount of power supplies the sensor. Thus, increases the life of the battery significantly.

The power saving device of the present invention is disposed in the mouse and has at least one sensor both contacts of which connect to a battery and a signal emitter respectively, and one window disposed on an upper surface of a housing of the mouse. The sensor arranged in the mouse housing is disposed under the window and uses the battery as operating power supply.

When the user holds the mouse and blocks the window, the sensor receives a correct signal reflected from the blocker and connects the operating power supply of the signal emitter to make the mouse operate normally. When the user does not use the computer for a while and the mouse is in a suspending mode, the sensor does not receive a correct signal and disconnects the operating power supply. Therefore, the signal emitter of the mouse does not need to perform scanning continuously. In the meantime, the battery with a very small amount of power supplies the sensor and, thus, the life of the battery is increased.

### BRIEF DESCRIPTION OF THE DRAWINGS

The foregoing and other features and advantages of the present invention will be more clearly understood from the following detailed description and the accompanying drawings, in which:

FIG. 1 is a perspective view showing a mouse of the present invention;

FIG. 2 shows the electrical connection of the sensor of the present invention;

FIG. 3 is a block diagram showing the connection of the battery, the sensor and the signal emitter;

FIG. 4 shows the holding of a mouse;

FIG. 5 is a cross-sectional view showing that the sensor receives a correct signal reflected from a blocker when the user holds the mouse;

FIG. 6 shows that the sensor compares transmitted and received reflected signal;

FIG. 7 shows the sensor receiving no reflected signal;

FIG. 8a shows a waveform produced by an ordinary sunlight lamp;

FIG. 8b shows a waveform received in the circumstances without a light source in the night;

FIG. 8c shows a waveform produced by a fluorescent lamp;

FIG. 8d shows a waveform sent by a emitter of the sensor.

### DETAILED DESCRIPTION OF THE PREFERRED EMBODIMENT

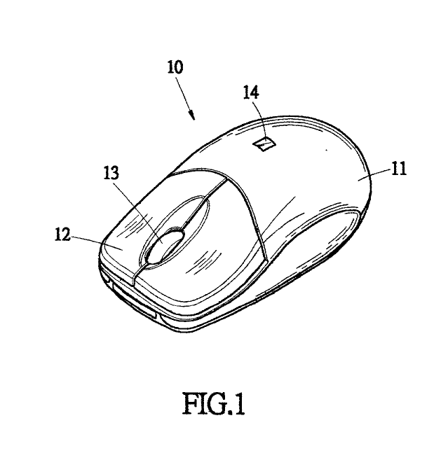

As shown in FIG. 1, the present invention provides a power saving device disposed in a wireless mouse 10. When the mouse 10 is under suspending mode, the power saving device can save the power consumption in order to increase the life of the battery.

As shown in FIGS. 1 to 7, the mouse 10 has a plurality of buttons 12 and a scroll wheel 13 disposed at the front of housing 11. A window 14, which is transparent, is disposed on an upper surface of the housing 11. A signal emitter 40 is disposed in the housing 11 to send wireless signals for the operation of a computer. A set of battery 30 used as operating power supply of the mouse 10.

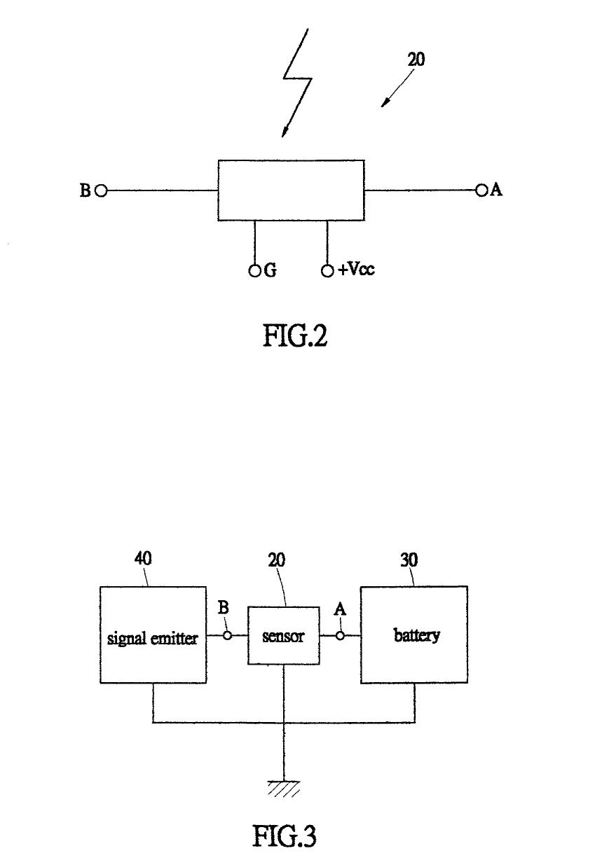

As shown in FIGS. 2 and 3, the power saving device comprises at least one sensor 20 having electrical contacts A and B in order to connect to the battery 30 and the signal emitter 40 respectively. The sensor 20 is disposed under the window 14 and uses the battery 30 as operating power supply.

As shown in FIGS. 1 and 3, when the user's hand approaches to the window 14, the sensor 20 receives a correct induced signal and performs a wake-up action. That is, connects the signal emitter 40 is connected to the operating power supply to make the mouse operated normally.

The sensor 20 has an emitter 21 and a receiver 22. A Wake-Up action is performed only when the light sent from the emitter 21 is reflected and the receiver 22 receives and identifies a light with the same waveform of the reflected light.

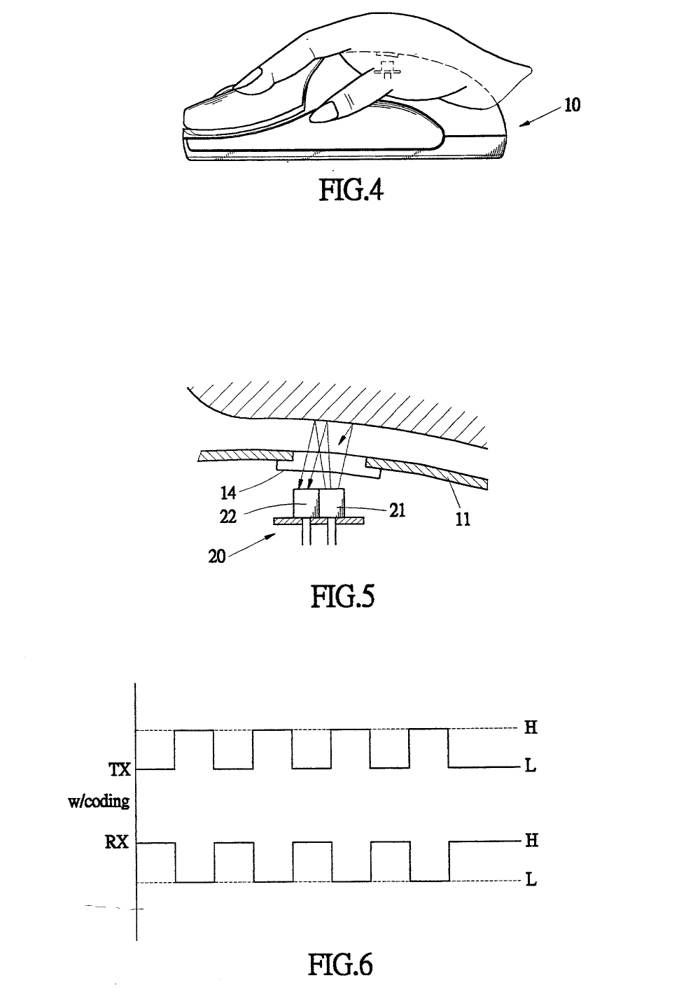

FIGS. 4, 5 and 6 show the sensor 20 receiving the correct induced signal. As shown in FIG. 5, when the user's hand approaches to the window 14, the signal sent by the emitter 21 of the sensor 20 is blocked by the hand and reflected to the receiver 22 of the sensor 20. As shown in FIG. 6, the reflected signal is a correct signal if such reflected signal corresponds to the transmitted signal, and the sensor 20 then connects the operating power supply of the signal emitter 40 to make the mouse operate normally.

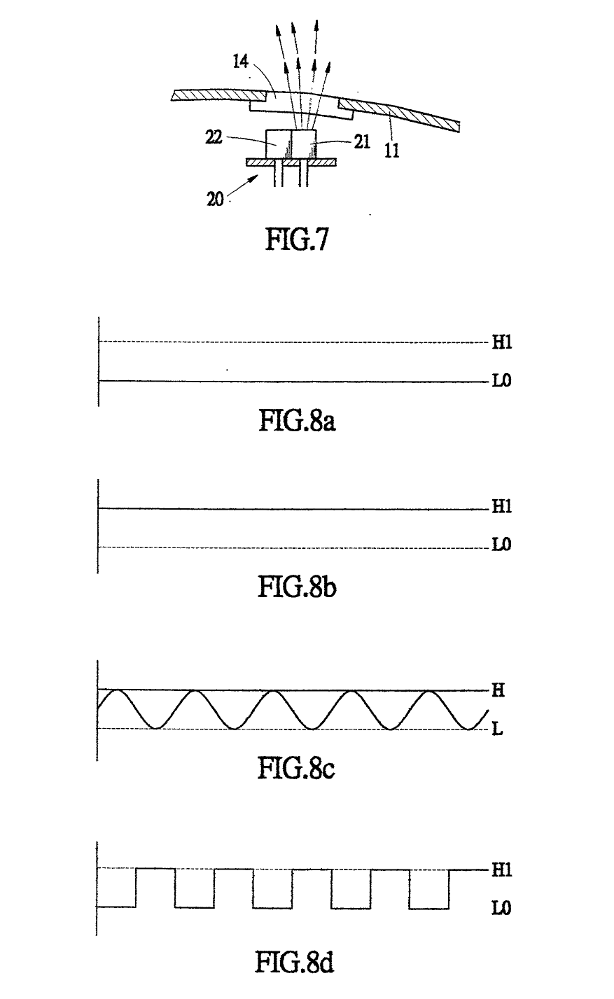

As shown in FIGS. 7, 8a, 8b and 8c, when the user does not use the computer for a while, the computer is in the suspending mode. Since the mouse 10 is not held, the signal sent by the emitter 21 of the sensor 20 is not blocked by the palm, nor reflected to the receiver 22 of the sensor 20. In this circumstance, receiver 22 does not receive any correct reflected signal. Even though an external light with a waveform produced by a sunlight lamp (FIG. 8a), in the circumstances without a light source in the night (FIG. 8b) or by a fluorescent lamp (FIG. 8c) is received, the receiver 22 of the sensor 20 will compare the waveform with the correct waveform (FIG. 8d). If the receiver 22 in the comparison identifies a different waveform, the sensor 20 does not connect the operating power supply, the signal emitter 40 is not supplied with power and does not perform scanning continuously. In the meantime, the battery 30 supplies the sensor 20 with a very small amount power in the suspending mode, and, consequently, the life of the battery 30 is increased.

Since the remote Wake-Up action of conventional wireless mouse is triggered by performing scanning once per second and needs more power, the life of the battery is decreased. With the power saving device of the present invention that uses the sensor 20 for the Wake-Up control, the consumption of the power is 100 times the consumption of the prior art mouse. Further, the sensor 20 disconnects the power of the signal emitter 40 in the suspending mode so the mouse 10 does not need to perform scanning continuously any more. In the meantime, the battery 30 with a very small amount power supplies the sensor 20, and, consequently, the life of the battery 30 is increased.

With the sensor of the present invention, the power consumption of the mouse in the suspending and Wake-Up modes is lowered down to a minimum and the problem of power consumption of the prior art mouse is solved effectively. Further, the present invention has a special structure and is capable to increase the life of the battery significantly.

Although the present invention has been illustrated and described with reference to the preferred embodiment thereof, it should be understood that it is in no way limited to the details of such embodiment but is capable of numerous modifications within the scope of the appended claims.

What is claimed is:

1. A power saving device disposed in a wireless mouse having a plurality of buttons and a scroll wheel disposed on a control end at the front of housing of the mouse, a signal emitter disposed in the housing to send wireless signals for the operation of a computer, and a set of battery used as operating power supply of the mouse, comprising:
a window disposed on an upper surface of said housing;
at least one sensor both contacts of which connect to said battery and said signal emitter, respectively, said sensor being disposed under said window and using said battery as operating power supply; and
triggering said sensor and connecting said operating power supply when a user holds the mouse, and disconnecting power supplied to said signal emitter when the user does not use said computer for a while and the mouse is in a suspending mode so that said signal emitter does not perform scanning continuously any more to conserve said battery.

2. The power saving device as claimed in claim 1, wherein said sensor comprises a emitter and a receiver, a signal sent from said emitter is blocked and reflected to said receiver, and the operating power supply is connected when said receiver receives a signal same as the signal sent from said emitter.
